(19) United States
(12) Patent Application Publication
(10) Pub. No.: US 2023/0284825 A1
(43) Pub. Date: Sep. 14, 2023

(54) Crockpot Liner Device

(71) Applicant: Austin Gause, Rockford, OH (US)

(72) Inventor: Austin Gause, Rockford, OH (US)

(21) Appl. No.: 18/165,397

(22) Filed: Feb. 7, 2023

Related U.S. Application Data
(60) Provisional application No. 63/318,067, filed on Mar. 9, 2022.

(51) Int. Cl. A47J 36/16; A47J 36/02; B65D 33/25

(52) U.S. Cl. CPC A47J 36/16; A47J 36/022; B65D 33/2541

(57) ABSTRACT

The present invention relates to a novel crockpot liner device. The device is a large crockpot liner with a Ziploc-type fastener as its top. The crockpot liner device comprises a body component that is a single piece of material shaped in a bag-like configuration with a closed bottom portion and an open top portion. The body component is sized and shaped to fit within the interior of a crockpot. Further, the top portion of the body component comprises a resealable fastener, which allows a user to seal and unseal the body component, as needed.

### CROSS-REFERENCE TO RELATED APPLICATION

The present application claims priority to, and the benefit of, U.S. Provisional Application No. 63/318,067, which was filed on Mar. 9, 2022, and is incorporated herein by reference in its entirety.

### FIELD OF THE INVENTION

The present invention relates generally to the field of crockpot liner devices. More specifically, the present invention relates to an improved crockpot liner device that provides users with a Ziploc-type liner for a quick and convenient way to store crockpot leftovers after meal preparation. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in crockpot liner devices. Generally, preparing food in a crockpot can be a messy experience. Often, food is baked on the sides of the crockpot and is difficult to remove. Further, when not using a crockpot, dust may accumulate inside the crockpot.

Additionally, while crock pots provide even or substantially uniform heat conduction throughout its interior chamber and require minimal electrical energy to operate, some food may burn or otherwise stick to the interior chamber walls making it difficult to scrape off during cleaning. Moreover, some crock pots have a conventional ceramic or stoneware interior cooking chamber, which does not contain a non-stick surface.

What is needed is a liner for slow cooking units, such as a crockpot, that is disposable and which does not interfere with the operation of the crockpot as it operates to cook food. Further, a Ziploc-type liner is also needed for storing food directly from the crockpot. The liners should provide a clean cooking environment and be simple to manufacture, thereby allowing a user to prepare meals in the cookware without having the mess associated with such cooking. Such a liner requires simplicity for manufacturing high volumes of liners, and preferably should be readily disposable after use.

Therefore, there exists a long-felt need in the art for a crockpot liner device that provides users with a Ziploc-type liner for a quick and convenient way to store crockpot leftovers after meal preparation. There is also a long-felt need in the art for a crockpot liner device that features a body of material that would form to the shape of the crockpot interior. Further, there is a long-felt need in the art for a crockpot liner device that features a resealable top portion for storing food within. Moreover, there is a long-felt need in the art for a device that is used to keep a crockpot clean and clear of mess. Further, there is a long-felt need in the art for a crockpot liner device that eliminates the need for multiple storage containers for leftover food. Finally, there is a long-felt need in the art for a crockpot liner device that reduces the time spent cleaning, soaking, and scrubbing stubborn, stuck-on food residue from a crockpot.

The subject matter disclosed and claimed herein, in one embodiment thereof, comprises a crockpot liner device. The device is a large crockpot liner with a Ziploc-type fastener as its top. The crockpot liner device comprises a body component that is a single piece of material shaped in a bag-like configuration with a closed bottom portion and an open top portion. The body component is sized and shaped to fit within the interior of a crockpot. Further, the body component would be manufactured of a flexible material, that will form to the shape of the crockpot interior when in use. Further, the top portion of the body component comprises a resealable fastener, which allows a user to seal and unseal the body component, as needed.

Accordingly, the crockpot liner device would solve the process of bagging and storing leftover crockpot food. The user would simply place the device inside the crockpot before placing ingredients and food inside to cook. The user then cooks and serves the food from inside the crockpot. Once the food is done being served, the user may pull the device up and out of the crockpot. Then, the user seals the top portion of the device with the Ziploc-type fastener, securing the food within the device. The user then places the device and food in the refrigerator or freezer. Thus, the crockpot liner device allows for easy cleanup and storage of leftover food.

In this manner, the crockpot liner device of the present invention accomplishes all of the foregoing objectives and provides users with a device that eliminates the need for multiple storage containers for leftover food. The device is a large crockpot liner with a Ziploc-type fastener at the top. The device fits most standard crockpots and can be manufactured in multiple sizes based on a user’s preferences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subj ect matter disclosed and claimed herein, in one embodiment thereof, comprises a crockpot liner device. The device is a large crockpot liner with a Ziploc-type fastener as its top. The crockpot liner device comprises a body component that is a single piece of material shaped in a bag-like configuration with a closed bottom portion and an open top portion. The body component is sized and shaped to fit within the interior of a crockpot. Further, the body component would be manufactured of a flexible material that will form to the shape of the crockpot interior when in use. Further, the top portion of the body component comprises a resealable fastener which allows a user to seal and unseal the body component, as needed.

The present invention is a crockpot liner device for use in a slow cook device, such as a crockpot or similar cookware. A slow cooker or crockpot includes a lidded round or oval cooking pot made of glazed ceramic or porcelain surrounded by a housing, usually metal, containing an electric heating element. The lid may be made of glass and seated in a groove in the pot edge; condensed vapor collects in the groove and provides a low-pressure seal to the atmosphere. The “crock” or ceramic pot itself acts as both a cooking container and a heat reservoir. Slow cookers and crockpots come in capacities from 500 mL (17 US fl oz) to 7 L (7.4 US qt). However, because the heating elements are generally located at the bottom and often also part way up the sides, most slow cookers and crockpots have a minimum recommended liquid level to avoid uncontrolled heating.

The slow cooker or crockpot may include two or more heat settings (i.e., low, medium, high, and sometimes a “keep warm” setting) and may further include continuously variable power. The slow cooker or crockpot may include no temperature control and deliver a constant heat to the contents. The temperature of the contents rises until it reaches boiling point at which point the energy goes into gently boiling the liquid closest to the hot surface. At a lower setting, it may just simmer at a temperature below the boiling point.

Further, the crockpot preferably has a single cooking chamber within an interior wall and a bottom surface. The crockpot liner device comprises a body component comprising a conductive unitary main body portion integrally formed, the main body portion of the body component is shaped to substantially form with the crock pot’s interior wall surfaces.

Further, the body component is formed by conventional forming methods to have a depth of substantially the same or slightly less than the interior depth of the crockpot’s single interior chamber and to have a substantially flat or curved bottom surface that merges smoothly with all the surfaces of the crockpot’s interior walls so that the body component forms substantially with the interior chamber of the crockpot. Further, the body component’s side walls are preferably formed to lie in a plane substantially coincident with the plane of the interior inner crock-pot walls so that the body component conforms substantially to the configuration of the interior cooking surface of the crockpot. Similar to the overall design of the body component, the body component will also lie in plane substantially symmetrical to the rim of the crockpot but having a thickness that cooperates with and does not interfere with the operation of the crockpot lid.

The body component of the present invention can be sized either rectangle, round or square with measurements of 2 qt, 2.5 qt, 3 qt, 3.5 qt, 4 qt, 4.5 qt, 5 qt, 5.5 qt, 6 qt, 6.5 qt, 7 qt, 7.5 qt and 8 qt slow cookers or crockpots. The present invention can also be manufactured at 16 ounces or any other size. The present invention may be made thinner or thicker depending on heating ability in the slow cooker. The present invention may also come in a variety of colors.

In one embodiment, the device comprises a body component that includes a substantially flat base having an outer edge forming an oval shape. A sidewall extends vertically from the outer edge of the base. The sidewall includes a bottom rim and a top rim. The bottom rim is attached to the base and the top rim forms an opening leading into a receptacle of the body component.

In one embodiment, the crockpot liner device preferably is formed from a tear-resistant material which substantially eliminates tears, spills and leaks from occurring. Further, the device is preferably formed of material which is resistant to oil, water moisture, grease, and foodstuff, yet allows sufficient conduction of energy (such as, for example, heat energy) to be transferred through its structure walls. Further, the device is made of food- grade material and is bisphenol A (BPA) free, thereby making the devices safe to use. The crockpot liner device also has the advantage that it is easily disposable, easily recyclable and biodegradable. In one embodiment, the present invention is reusable and will be designed to allow multiple uses, if necessary.

A significant advantage of the present invention is the ability to substantially eliminate the cleaning associated with crockpot use. During conventional crockpot usage, food is slow cooked over time without much attention given to the crockpot by the user, thereby resulting in foodstuff sticking to the interior chamber walls of the crockpot. With the present invention, after the food is cooked, the user can easily discard the body component if there is no food to store. Thus, there is no need to clean the body component, as a new crockpot liner device can be utilized the next time the crockpot is used.

In one embodiment, the top portion of the body component can be reclosed when needed. Generally, the top portion comprises Ziploc-type closures/fasteners or profiled closures/fasteners with two cooperating profile strips. Such profiled closures can be connected to one another by pressing together the strips. Alternatively, a slider is attached onto the closure and encompasses the profile strips. The profile strips can be pulled apart or pushed together, i.e., opened or closed, by displacing the slider along the strips.

In one embodiment, the body component is a pouch or a bag with a Ziploc-type closure member attached to it. The bag comprises two side walls, the top upper edges of which are connected along the opening with cooperating profile strips of the closure. The connection between the bag and the cooperating profile strips can be produced by gluing, sealing, welding and/or sewing. The cooperating profile strips of the closure can be attached to the outside or the inside of the body component side walls.

Specifically, the means for sealing and opening the body component may comprise a closure member having a male profile strip disposed continuously along the outwardly top edge of the front panel and a female profile strip disposed continuously along the outwardly top edge of the back panel, where the body component is sealed as the male profile strip is engaged with the female profile strip in one direction and is opened as the male profile strip is disengaged from the female profile strip in the other direction. Particularly, the closure member may be disposed on inner surfaces of the front and back panels immediately below the top edge. As an example, the closure member may be a zipper comprising zipper profile strips disposed continuously along the top edges and a slider clip disposed on the zipper profiles where the body component is sealed as the slider clip couples the zipper profile strips in one direction and the body component is opened as the slider clip decouples the zipper profile strips in the other direction.

Furthermore, the first and second profile strips each comprises a pair of locking ribs for securing the first and second profile strips together. Specifically, the locking ribs of the first profile strip and the locking ribs of the second profile strip respectively extend parallel to one another in pairs and are respectively spaced apart from one another by the same distance. In use, the first profile strip completely encompasses the second profile strip, such that the second profile strip lies with its two locking ribs within the first profile strip.

This means that the two profile strips are pulled apart and mutually disengaged by increasing the distance between the pair of locking ribs. The sliding apart of the contact surfaces of the profile strips are simplified by the cylindrical peripheral surfaces of the pair of locking ribs. At the same time, the cylindrical design of the surfaces promotes interlocking of the two profile strips when they are united to close off the body component opening. However, the two profile strips can be disengaged only if they are correspondingly spread apart manually or by the slider. The connection cannot be disengaged by the pressure of the contents of the body component.

In one embodiment, the body component is in a partially opened state. The slider is displaced approximately to its left end position and has pulled apart the locking ribs, such that an opening is formed. The opening can be reclosed by displacing the slider toward the right. This displacement toward the right reunites the two locking ribs, such that the locking ribs are interlocked.

Thus, the body component is resealable via its closure member being engaged. As the closure member is engaged in one direction, the body component is sealed or closed and as the closure member is disengaged in the other direction, the body component is unsealed or opened. Engagement can be accomplished manually by running one’s fingers across the profile strips to seal the body component or pulling the profile strips apart to unseal the body component. Alternatively, the closure member may comprise a slider clip that engages and disengages the profile strips as it is moved back and forth across the body component. In one non-limiting example, the closure member may comprise zipper profile strips with a slider clip for engaging/disengaging the profile strips as is known in the art.

Accordingly, the crockpot liner device would solve the process of bagging and storing leftover crockpot food. The user would simply place the device inside the crockpot before placing their ingredients and food inside to cook. The user then cooks and serves the food from inside the crockpot. Once the food is done being served, the user may pull the device up and out of the crockpot. Then, the user seals the top portion of the device with the Ziploc-type fastener, securing the food within the device. The user then places the device and food in the refrigerator or freezer. Thus, the crockpot liner device allows for easy cleanup and storage of leftover food.

In yet another embodiment, the body component of the crockpot liner device provided herein is manufactured of plastic, for example, polyethylene, nylon, rip-stop nylon, or polyurethane-coated nylon, or any other suitable materials as is known in the art and is manufactured by conventional means. The body component can have a variety of volumes to receive and accommodate food or other non-foodstuff or storable items. Standard representative volumes range through pint, quart, half gallon, gallon, or larger sizes or their metric equivalents. However, the body component described herein is not limited in size. The pliable bag body can have any combination of width and length to accommodate a range of sizes and shapes of any storable food item.

In yet another embodiment, the crockpot liner device comprises a plurality of indicia.

In yet another embodiment, a method of utilizing a crockpot without having to clean, soak, or scrub stubborn, stuck-on food residue from the crockpot after use is disclosed. The method includes the steps of providing a crockpot liner device comprising a body component shaped in a bag-like configuration with a closed bottom portion and an open top portion with a Ziploc-type fastener. The method also comprises choosing a specific size of the crockpot liner device, depending on the needs and/or wants of a user. Further, the method comprises securing the crockpot liner device within the crockpot interior. The method also comprises filling the crockpot liner device with food and ingredients. Further, the method comprises cooking the food. Finally, the method comprises securing the crockpot liner device after eating, via the Ziploc-type fastener, and storing the device in a refrigerator or freezer.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the crockpot liner device of the present invention showing a small crockpot with the device inserted in accordance with the disclosed architecture;

FIG. 2 illustrates a perspective view of one embodiment of the crockpot liner device of the present invention showing a large crockpot with the device inserted in accordance with the disclosed architecture;

FIG. 3 illustrates a top perspective view of one embodiment of the crockpot liner device of the present invention showing the device inserted and open in a crockpot in accordance with the disclosed architecture;

FIG. 4 illustrates a perspective view of one embodiment of the crockpot liner device of the present invention in use in accordance with the disclosed architecture; and

FIG. 5 illustrates a flowchart showing the method of utilizing a crockpot without having to clean, soak, or scrub stubborn, stuck-on food residue from the crockpot after use in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a crockpot liner device that provides users with a Ziploc-type liner for a quick and convenient way to store crockpot leftovers after meal preparation. There is also a long-felt need in the art for a crockpot liner device that features a body of material that would form to the shape of the crockpot interior. Further, there is a long-felt need in the art for a crockpot liner device that features a resealable top portion for storing food within. Moreover, there is a long-felt need in the art for a device that is used to keep a crockpot clean and clear of mess. Further, there is a long-felt need in the art for a crockpot liner device that eliminates the need for multiple storage containers for leftover food. Finally, there is a long-felt need in the art for a crockpot liner device that reduces the time spent cleaning, soaking, and scrubbing a crockpot from stubborn, stuck-on food residue.

The present invention, in one exemplary embodiment, is a novel crockpot liner device. The device is a large crockpot liner with a Ziploc-type fastener as its top. The crockpot liner device comprises a body component that is a single piece of material shaped in a bag-like configuration with a closed bottom portion and an open top portion. The body component is sized and shaped to fit within the interior of a crockpot. Further, the top portion of the body component comprises a resealable fastener which allows a user to seal and unseal the body component, as needed. The present invention also includes a novel method of utilizing a crockpot without having to clean, soak, or scrub stubborn, stuck-on food residue from the crockpot after use. The method includes the steps of providing a crockpot liner device comprising a body component shaped in a bag-like configuration with a closed bottom portion and an open top portion with a Ziploc-type fastener. The method also comprises choosing a specific size of the crockpot liner device, depending on the needs and/or wants of a user. Further, the method comprises securing the crockpot liner device within the crockpot interior. The method also comprises filling the crockpot liner device with food and ingredients. Further, the method comprises cooking the food. Finally, the method comprises securing the crockpot liner device after eating, via the Ziploc-type fastener, and storing the device in a refrigerator or freezer.

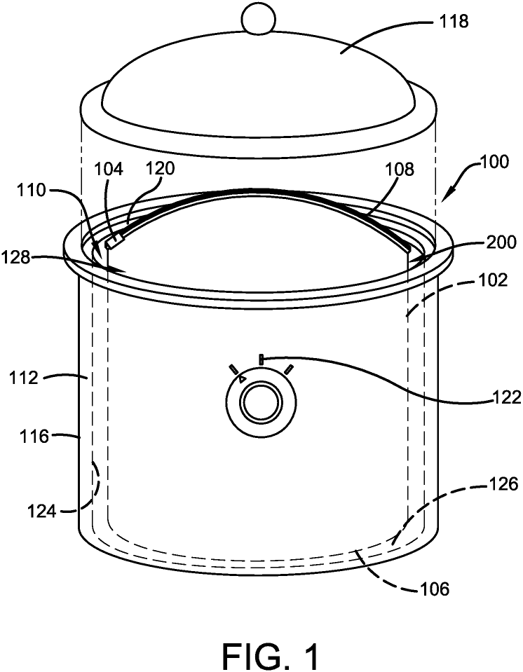

Referring initially to the drawings, FIG. 1 illustrates a perspective view of one embodiment of the crockpot liner device 100 of the present invention. In the present embodiment, the crockpot liner device 100 is an improved crockpot liner device 100 that provides a quick and convenient way to store crockpot leftovers after meal preparation. Further, the crockpot liner device 100 comprises a body component 102 with a Ziploc-type fastener 104 at its top. Specifically, the crockpot liner device 100 comprises a body component 102 that is a single piece of material shaped in a bag-like configuration with a closed bottom portion 106 and an open top portion 108. The body component 102 is sized and shaped to fit within the interior 110 of a crockpot 112. Further, the top portion 108 of the body component 102 comprises a resealable fastener 104 which allows a user to seal and unseal the body component 102, as needed.

Generally, the present invention is a crockpot liner device 100 for use in a slow cooker device, such as a crockpot 112 or similar cookware. A slow cooker or crockpot 112 includes a lidded round or oval cooking pot 114 made of glazed ceramic or porcelain surrounded by a housing 116, usually metal, containing an electric heating element (not shown). The lid 118 may be made of glass and seated in a rim groove 120 in the pot edge; condensed vapor collects in the groove 120 and provides a low-pressure seal to the atmosphere. The “crock” or ceramic pot 114 itself acts as both a cooking container and a heat reservoir. Slow cookers and crockpots 112 come in capacities from 500 mL (17 US fl oz) to 7 L (7.4 US qt). However, because the heating elements are generally located at the bottom and often also part way up the sides, most slow cookers and crockpots 112 have a minimum recommended liquid level to avoid uncontrolled heating.

The slow cooker or crockpot 112 may include two or more heat settings 122 (i.e., low, medium, high, and sometimes a “keep warm” setting) and may further include continuously variable power. The slow cooker or crockpot 112 may include no temperature control and deliver a constant heat to the contents. The temperature of the contents rises until it reaches boiling point, at which point the energy goes into gently boiling the liquid closest to the hot surface. At a lower setting, it may just simmer at a temperature below the boiling point.

Further, the crockpot 112 preferably has a single cooking chamber within an interior wall 124 and a bottom surface 126. The crockpot liner device 100 comprises a body component 102 comprising a conductive unitary main body portion 128 integrally formed, the main body portion 128 of the body component 102 is shaped to substantially form with the crock pot’s interior wall surfaces 124.

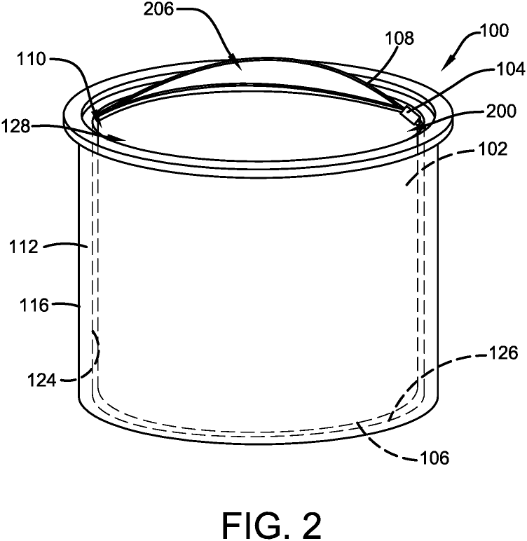

As shown in FIG. 2, the body component 102 is formed by conventional forming methods to have a depth of substantially the same or slightly less than the interior depth of the crockpot’s single interior chamber 110 and to have a substantially flat or curved bottom surface that merges smoothly with all the surfaces of the crockpot’s interior walls 124 so that the body component 102 forms substantially with the interior chamber 110 of the crockpot 112. Further, the body component’s side walls 200 are preferably formed to lie in a plane substantially coincident with the plane of the interior inner crockpot walls 124 so that the body component 102 conforms substantially to the configuration of the interior cooking surface 110 of the crockpot 112. Similar to the overall design of the body component 102, the body component 102 will also lie in plane substantially symmetrical to the rim groove 120 of the crockpot 112 but has a thickness that cooperates with and does not interfere with the operation of the crockpot lid 118.

The body component 102 of the present invention can be sized either rectangular, round or square with measurements of 2 qt, 2.5 qt, 3 qt, 3.5 qt, 4 qt, 4.5 qt, 5 qt, 5.5 qt, 6 qt, 6.5 qt, 7 qt, 7.5 qt and 8 qt slow cookers or crockpots 112. The present invention can also be manufactured at 16 ounces or any other suitable sizes as is known in the art. The present invention may be made thinner or thicker depending on the heating ability in the slow cooker or crockpot 112. The present invention may also come in a variety of colors.

Furthermore, in one embodiment, the device 100 comprises a body component 102 that includes a substantially flat base 202 having an outer edge 204 forming an oval shape. A sidewall 200 extends vertically from the outer edge 204 of the body component 102. The sidewall 200 includes a bottom portion 106 and a top portion 108. The bottom portion 106 is attached to the base 202 and the top portion 108 forms an opening 206 leading into a receptacle of the body component 102.

Additionally, the crockpot liner device 100 preferably is formed from a tear-resistant material which substantially eliminates tears, spills, and leaks from occurring. Further, the device 100 is preferably formed of material which is resistant to oil, water moisture, grease, and foodstuff, yet allows sufficient conduction of energy (such as, for example, heat energy) to be transferred through its structure walls 124. Further, the device 100 is made of food- grade material and is bisphenol A (BPA) free, thereby making the device 100 safe to use. The crockpot liner device 100 also has the advantage that it is easily disposable, easily recyclable, and biodegradable. However, in one embodiment, the present invention is reusable and will be designed to allow multiple uses, depending on the needs and/or wants of a user.

A significant advantage of the present invention is the ability to substantially eliminate the cleaning associated with crockpot use. During conventional crockpot usage, food is slow cooked over time without much attention given to the crockpot 112 by the user, thereby resulting in foodstuff sticking to the interior chamber walls 124 of the crockpot 112. With the present invention, after the food is cooked, the user can easily discard the body component 102 if there is no food to store. Thus, there is no need to clean the body component 102 as a new crockpot liner device 100 can be utilized the next time the crockpot 112 is used.

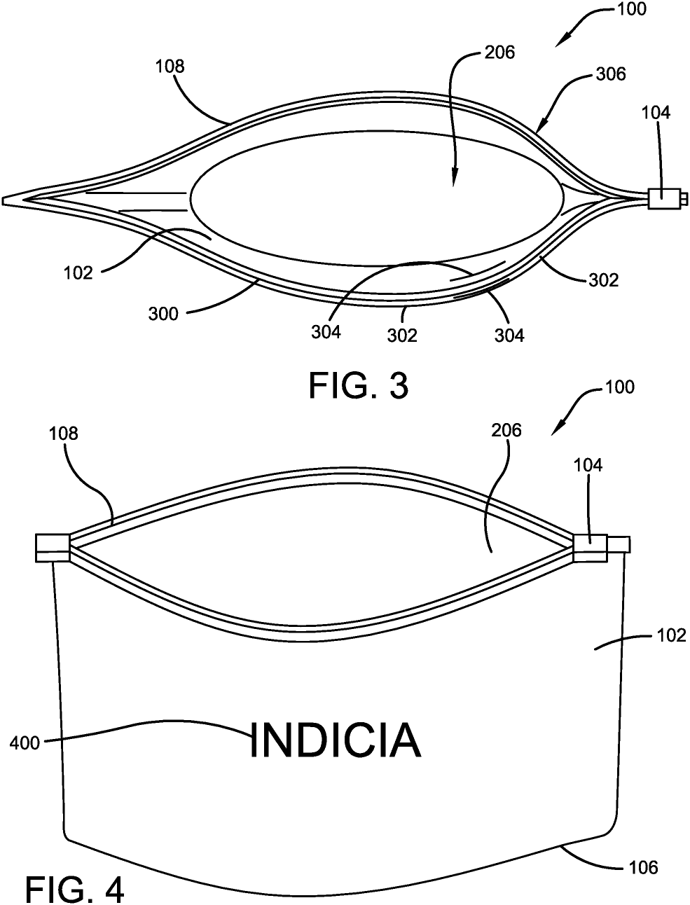

As shown in FIG. 3, the top portion 108 of the body component 102 can be reclosed when needed. Generally, the top portion 108 comprises Ziploc-type closures/fasteners 104 (i.e., a slider) or profiled closures/fasteners 300 with two cooperating profile strips 302. Such profiled closures 300 can be connected to one another by pressing together the strips 302. Alternatively, a slider 104 is attached onto the closure and encompasses the profile strips 302. The profile strips 302 can be pulled apart or pushed together, i.e., opened or closed, by displacing the slider 104 along the strips 302.

Further, the body component 102 is a pouch or a bag with a Ziploc-type closure member 104 attached to it. The body component 102 comprises two side walls 200, the top upper edges 108 of which are connected along the opening 206 with cooperating profile strips 302 of the closure. The connection between the body component 102 and the cooperating profile strips 302 can be produced by gluing, sealing, welding, and/or sewing, etc., or any other suitable securing means as is known in the art. The cooperating profile strips 302 of the closure can be attached to the outside or the inside of the body component side walls 200, depending on the wants and/or needs of a user.

Specifically, the means for sealing and opening the body component 102 may comprise a closure member 104 or 300 having a male profile strip 302 disposed continuously along the outwardly top edge 108 of the front of the sidewall 200 and a female profile strip 302 disposed continuously along the outwardly top edge 108 of the back of the sidewall 200, wherein the body component 102 is sealed as the male profile strip 302 is engaged with the female profile strip 302 in one direction and is opened as the male profile strip 302 is disengaged from the female profile strip 302 in the other direction. Particularly, the closure member 104 or 300 may be disposed on the inner surfaces of the front and back sidewalls 200 immediately below the top portion 108. As a representative example, the closure member 104 or 300 may be a zipper/slider comprising zipper profile strips 302 disposed continuously along the top edges 108 and a slider clip 104 disposed on the zipper profile strips 302, wherein the body component 102 is sealed as the slider clip 104 couples the zipper profile strips 302 in one direction and the body component 102 is opened as the slider clip 104 decouples the zipper profile strips 302 in the other direction.

Furthermore, the first and second profile strips 302 each comprise a pair of locking ribs 304 for securing the first and second profile strips 302 together. Specifically, the locking ribs 304 of the first profile strip 302 and the locking ribs 304 of the second profile strip 302 respectively extend parallel to one another in pairs and are respectively spaced apart from one another by the same distance. In use, the first profile strip 302 completely encompasses the second profile strip 302, such that the second profile strip 302 lies with its two locking ribs 304 within the first profile strip 302.

This means that the two profile strips 302 are pulled apart and mutually disengaged by increasing the distance between the pair of locking ribs 304. The sliding apart of the contact surfaces of the profile strips 302 are simplified by the cylindrical peripheral surfaces 306 of the pair of locking ribs 304. At the same time, the cylindrical design of the surfaces 306 promotes interlocking of the two profile strips 302 when they are united to close off the body component 102 opening 206. However, the two profile strips 302 can be disengaged only if they are correspondingly spread apart manually 300 or by the slider 104. The connection cannot be disengaged by the pressure of the contents of the body component 102, thus, safely sealing the leftover food within the device 100.

In one embodiment, the body component 102 is in a partially opened state. The slider 104 is displaced approximately to its left end position and has pulled apart the locking ribs 304 such that an opening 206 is formed. The opening 206 can be reclosed by displacing the slider 104 toward the right. This displacement toward the right reunites the two locking ribs 304 such that the locking ribs 304 are interlocked.

Thus, the body component 102 is resealable via its closure member 104 or 300 being engaged. As the closure member 104 or 300 is engaged in one direction, the body component 102 is sealed or closed and as the closure member 104 or 300 is disengaged in the other direction, the body component 102 is unsealed or opened. Engagement can be accomplished manually 300 by running one’s fingers across the profile strips 302 to seal the body component 102 or pulling the profile strips 302 apart to unseal the body component 102. Alternatively, the closure member 104 or 300 may comprise a slider clip 104 that engages and disengages the profile strips 302 as it is moved back and forth across the body component 102. In one non-limiting example, the closure member 104 or 300 may comprise zipper profile strips 302 with a slider clip 104 for engaging/disengaging the profile strips 302 as is known in the art, but any other suitable closure members can be utilized as is known in the art, depending on the needs and/or wants of a user.

As shown in FIG. 4, the crockpot liner device 100 would solve the process of bagging and storing leftover crockpot food. The user would simply place the device 100 inside the crockpot 112 before placing their ingredients and food inside to cook. The user then cooks and serves the food from inside the crockpot 112. Once the food is done being served, the user may pull the device 100 up and out of the crockpot 112. Then, the user seals the top portion 108 of the device 100 with the Ziploc-type fastener 104, securing the food within the device 100. The user then places the device 100 and food in the refrigerator or freezer. Thus, the crockpot liner device 100 allows for easy cleanup and storage of leftover food.

Furthermore, the body component 102 of the crockpot liner device 100 provided herein is manufactured of plastic, for example, polyethylene, nylon, rip-stop nylon, or polyurethane-coated nylon, or any other suitable materials as is known in the art and is manufactured by conventional means. The body component 102 can have a variety of volumes to receive and accommodate food or other non-foodstuff or storable items. Standard representative volumes range through pint, quart, half-gallon, gallon, or larger sizes or their metric equivalents. However, the body component 102 described herein is not limited in size. The pliable bag body of the body component 102 can have any combination of width and length to accommodate a range of sizes and shapes of any storable food item as is known in the art, depending on the needs and/or wants of a user.

Furthermore, the crockpot liner device 100 comprises a plurality of indicia 400. The body component 102 of the device 100 may include advertising, trademark, or other letters, designs, or characters, printed, painted, stamped, or integrated into the body component 102, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be crockpot, food, or brand related.

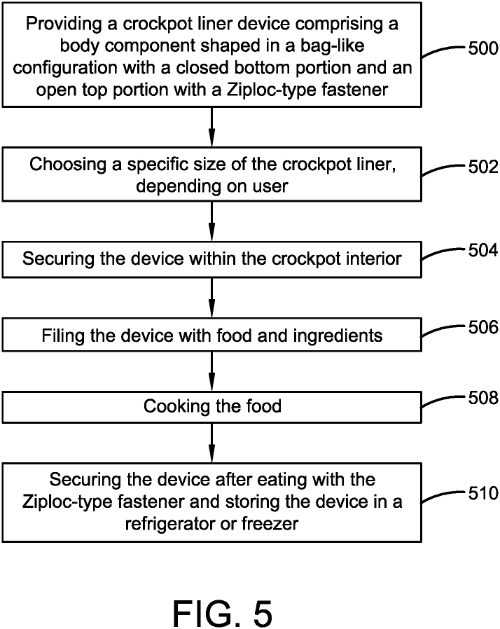

FIG. 5 illustrates a flowchart of the method of utilizing a crockpot without having to clean, soak, or scrub stubborn, stuck-on food residue from the crockpot after use. The method includes the steps of at 500, providing a crockpot liner device comprising a body component shaped in a bag-like configuration with a closed bottom portion and an open top portion with a Ziploc-type fastener. The method also comprises at 502, choosing a specific size of the crockpot liner device, depending on the needs and/or wants of a user. Further, the method comprises at 504, securing the crockpot liner device within the crockpot interior. The method also comprises at 506, filling the crockpot liner device with food and ingredients. Further, the method comprises at 508, cooking the food. Finally, the method comprises at 510, securing the crockpot liner device after eating, via the Ziploc-type fastener and storing the device in a refrigerator or freezer.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “crockpot liner device”, “crockpot device”, “liner device”, and “device” are interchangeable and refer to the crockpot liner device 100 of the present invention.

Notwithstanding the foregoing, the crockpot liner device 100 of the present invention can be of any suitable size and configuration as is known in the art without affecting the overall concept of the invention, provided that it accomplishes the above- stated objectives. One of ordinary skill in the art will appreciate that the crockpot liner device 100 as shown in FIGS. 1-5 are for illustrative purposes only, and that many other sizes and shapes of the crockpot liner device 100 are well within the scope of the present disclosure. Although the dimensions of the crockpot liner device 100 are important design parameters for user convenience, the crockpot liner device 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A crockpot liner device that provides a quick and convenient way to store crockpot leftovers after meal preparation, the crockpot liner device comprising:
a body component shaped in a bag-like configuration with a closed bottom portion and an open top portion, wherein the body component is sized and shaped to fit within an interior of a slow cooker device; and
a resealable fastener positioned at the open top portion, wherein the resealable fastener allows a user to seal and unseal the body component as needed.

2. The crockpot liner device of claim 1, wherein the slow cooker device is a crockpot.

3. The crockpot liner device of claim 2, wherein the crockpot has a single cooking chamber within an interior wall and a bottom surface.

4. The crockpot liner device of claim 3, wherein the body component comprises a conductive unitary main body portion integrally formed and shaped to substantially form with the single cooking chamber.

5. The crockpot liner device of claim 4, wherein the body component comprises a substantially flat base with two sidewalls that extend vertically from the substantially flat base.

6. The crockpot liner device of claim 5, wherein the two sidewalls include the closed bottom portion and the open top portion, wherein the closed bottom portion is attached to the substantially flat base and the open top portion forms an opening leading into a receptacle of the body component.

7. The crockpot liner device of claim 6, wherein the crockpot liner device is disposable.

8. The crockpot liner device of claim 7, wherein the resealable fastener is a Ziploc-type fastener or a profiled fastener with two cooperating profile strips.

9. The crockpot liner device of claim 8, wherein the profiled fastener secures the two cooperating profile strips to one another by pressing together the two cooperating profile strips.

10. The crockpot liner device of claim 9, wherein the Ziploc-type fastener secures the two cooperating profile strips to one another by a slider that encompasses the two cooperating profile strips, wherein the two cooperating profile strips can be pulled apart or pushed together by displacing the slider along the two cooperating profile strips.

11. The crockpot liner device of claim 10, wherein the two cooperating profile strips comprise a male profile strip disposed along the open top portion of one of the two sidewalls and a female profile strip disposed along the open top portion of another of the two sidewalls, wherein the body component is sealed as the male profile strip is engaged with the female profile strip in one direction and is opened as the male profile strip is disengaged from the female profile strip in another direction.

12. The crockpot liner device of claim 11, wherein the two cooperating profile strips each comprise a pair of locking ribs for securing the two cooperating profile strips together.

13. The crockpot liner device of claim 12, wherein one of the two cooperating profile strips completely encompasses another of the two cooperating profile strips, such that the another of the two cooperating profile strips lies with its pair of locking ribs within the one of the two cooperating profile strips.

14. A crockpot liner device that provides a quick and convenient way to store crockpot leftovers after meal preparation, the crockpot liner device comprising:
a body component shaped in a bag-like configuration with a closed bottom portion and an open top portion; and
a resealable Ziploc-type fastener positioned at the open top portion with two cooperating profile strips; and
wherein the body component is sized and shaped to fit within an interior of a slow cooker device;
wherein the body component comprises a substantially flat base with two sidewalls that extend vertically from the substantially flat base;
wherein the two sidewalls include the closed bottom portion and the open top portion, wherein the closed bottom portion is attached to the substantially flat base and the open top portion forms an opening leading into a receptacle of the body component;
wherein the resealable Ziploc-type fastener secures the two cooperating profile strips to one another by a slider that encompasses the two cooperating profile strips, wherein the two cooperating profile strips can be pulled apart or pushed together by displacing the slider along the two cooperating profile strips; and
further wherein the two cooperating profile strips comprise a male profile strip disposed along the open top portion of one of the two sidewalls and a female profile strip disposed along the open top portion of another of the two sidewalls, wherein the body component is sealed as the male profile strip is engaged with the female profile strip in one direction and is opened as the male profile strip is disengaged from the female profile strip in another direction.

15. The crockpot liner device of claim 14, wherein the slow cooker device is a crockpot.

16. The crockpot liner device of claim 14 further comprising a plurality of indicia.

17. The crockpot liner device of claim 14, wherein the crockpot liner device is disposable.

18. The crockpot liner device of claim 14, wherein the two cooperating profile strips each comprise a pair of locking ribs for securing the two cooperating profile strips together.

19. The crockpot liner device of claim 18, wherein one of the two cooperating profile strips completely encompasses another of the two cooperating profile strips, such that the another of the two cooperating profile strips lies with its pair of locking ribs within the one of the two cooperating profile strips.

20. A method of utilizing a crockpot without having to clean, soak, or scrub stubborn, stuck-on food residue from the crockpot after use, the method comprising the following steps:
providing a crockpot liner device comprising a body component shaped in a bag-like configuration with a closed bottom portion and an open top portion with a Ziploc-type fastener;
choosing a specific size of the crockpot liner device, depending on the needs and/or wants of a user;
securing the crockpot liner device within the crockpot interior;
filling the crockpot liner device with food and ingredients;
cooking the food; and
securing the crockpot liner device after eating, via the Ziploc-type fastener and storing the device in a refrigerator or freezer.
